(19) United States
(12) Patent Application Publication
(10) Pub. No.: US 2026/0296933 A1
(43) Pub. Date: Oct. 1, 2026

(54) WATER TREATMENT SYSTEM, PURE WATER PRODUCTION METHOD, AND WATER TREATMENT METHOD

(71) Applicant: ORGANO CORPORATION, Tokyo (JP)

(72) Inventors: Yusuke TAKAHASHI, Tokyo (JP); Keisuke SASAKI, Tokyo (JP); Kazushige TAKAHASHI, Tokyo (JP)

(73) Assignee: ORGANO CORPORATION, Tokyo (JP)

(21) Appl. No.: 19/698,105

(22) Filed: Jun. 4, 2026

Related U.S. Application Data
(62) Division of application No. 18/025,272, filed on Aug. 31, 2021.

(30) Foreign Application Priority Data
Sep. 10, 2020 (JP) 2020-152091
Aug. 25, 2021 (JP) 2021-137253

(51) Int. Cl. C02F 1/76; C02F 1/00; C02F 1/42; C02F 101/38; C02F 103/04

(52) U.S. Cl. CPC C02F 1/766; C02F 1/008; C02F 1/42; C02F 2001/422; C02F 2101/38; C02F 2103/04; C02F 2209/22; C02F 2303/185

(57) ABSTRACT

A method of producing pure water including adding halogen oxoacid to water to be treated that contains organic materials and supplying the water to be treated to which the halogen oxoacid has been added to an ion exchanger loaded apparatus in which at least anion exchangers are loaded. A concentration of divalent anions in the water to be treated is 0.4 mmol/L or less at an inlet of the ion exchanger loaded apparatus.

### CROSS-REFERENCE TO RELATED APPLICATIONS

This is a Divisional of U.S. patent application Ser. No. 18/025,272, which is a US National Stage entry of International Pat. Appl. No. PCT/JP2021/031987, filed Aug. 31, 2021, which claims the benefit of Japanese Pat. Appl. No. 2020-filed on Sep. 10, 2020, and Japanese Pat. Appl. No. 2021-137253 filed on Aug. 25, 2021. The disclosure of each of the above-mentioned documents, including the specification, drawings, and claims, is incorporated herein by reference in its entirety.

### FIELD OF THE INVENTION

The present application is based on and claims priority from JP2020-filed on Sep. 10, 2020, and JP2021-137253 filed on Aug. 25, 2021, the disclosures of which are hereby incorporated by reference herein in their entirety.

The present invention relates to a water treatment system, a method of producing pure water, and a water treatment method.

### BACKGROUND OF THE INVENTION

As strict demand for the water quality of pure water has been rising, various methods have been recently studied to decompose and remove the small amount of organic materials that are contained in pure water. JP2011-183275 and JP2012-11356 disclose methods of removing urea by adding sodium bromide and sodium hypochlorite to water to be treated that contains urea and then keeping the water to be treated in a reaction tank.

### SUMMARY OF THE INVENTION

The methods that are disclosed in JP2011-183275 and JP2012-11356 require that the water to be treated be kept in a reaction tank for a long time and cannot efficiently remove urea. The present invention aims at providing a water treatment system that can effectively remove persistent organic materials.

A water treatment system according to the invention comprises: means for adding halogen oxoacid that adds halogen oxoacid to water to be treated that contains organic materials; and an ion exchanger loaded apparatus that is positioned downstream of the means for adding halogen oxoacid, wherein at least anion exchangers are loaded in the ion exchanger loaded apparatus. The water to be treated to which the halogen oxoacid has been added is supplied to the ion exchanger loaded apparatus.

According to the present invention, it is possible to provide a water treatment system that can effectively remove persistent organic materials.

The above and other objects, features, and advantages of the present invention will become apparent from the following description with reference to the accompanying drawings which illustrate examples of the present invention.

### BRIEF DESCRIPTION OF THE DRAWINGS

FIG. 1 is a schematic view of the arrangement of an apparatus for producing pure water according to a first embodiment;

FIG. 2 is a schematic view of the arrangement of an apparatus for producing pure water according to a second embodiment;

FIG. 3 is a schematic view of the arrangement of an apparatus for producing pure water according to a third embodiment;

FIG. 4 is a schematic view of the arrangement of an apparatus for producing pure water according to a fourth embodiment;

FIG. 5 is a schematic view of the arrangement of an apparatus for producing pure water according to a fifth embodiment;

FIG. 6 is a schematic view of the arrangement of an apparatus for producing pure water according to a sixth embodiment;

FIG. 7 is a schematic view of the arrangement of an apparatus for producing pure water according to a seventh embodiment;

FIG. 8 is a graph that shows the relationship between spatial velocity of water to be treated and the removal rate of urea; and

FIG. 9 is a graph that shows the relationship between time duration over which the water to be treated was supplied and the removal rate of urea.

### DESCRIPTION OF EMBODIMENTS

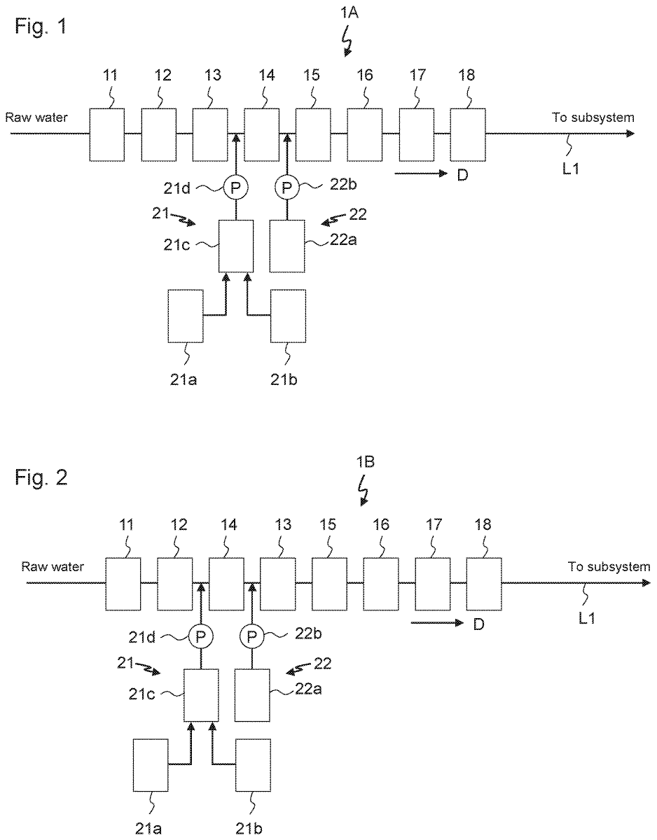

A water treatment apparatus, a method of producing pure water, and a water treatment method of the present invention will now be described with reference to the drawings. FIG. 1 schematically illustrates the arrangement of apparatus for producing pure water 1A according to the first embodiment of the present invention. Apparatus for producing pure water 1A (a primary system) constitutes an apparatus for producing ultrapure water together with an upstream pretreatment system and a downstream subsystem (a secondary system). Raw water (that is hereinafter referred to as water to be treated) that is supplied to apparatus for producing pure water 1A contains organic materials that include urea.

Apparatus for producing pure water 1A includes filter device 11, activated carbon tower 12, first ion exchanger apparatus 13, ion exchanger loaded apparatus 14, reverse osmosis membrane apparatus 15, ultraviolet ray radiating apparatus (an ultraviolet ray oxidation apparatus) 16, second ion exchanger apparatus 17, and deaerator apparatus 18, and these apparatuses are arranged in a series along main line L1 from upstream to downstream in flow direction D of the water to be treated in the order mentioned above. The water to be treated is pressurized by a raw water pump (not illustrated), and thereafter large dust and the like having relatively large particle diameters is removed by filter device 11. Then, impurities such as high-molecular organic materials are removed by activated carbon tower 12. Although a sand filter device is used in the present embodiment, the configuration of filter device 11 is not limited. First ion exchanger apparatus 13 includes a cation tower (not illustrated) in which cation exchanger resins are loaded, a decarboxylation tower (not illustrated), and an anion tower (not illustrated) in which anion exchanger resins are loaded, and these towers are arranged in a series from upstream to downstream in the order mentioned above. Cation components in the water to be treated are removed by the cation tower, carbonic acid in the water to be treated is removed by the decarboxylation tower, and anion components in the water to be treated are removed by the anion tower.

Apparatus for producing pure water 1A includes means for adding halogen oxoacid 21 that adds halogen oxoacid to the water to be treated that contains urea. Halogen oxoacid may exist in the form of ions or acid depending on the pH. Halogen oxoacid is a general term that includes these forms. Halogen oxoacid is hypohalous acid in the present embodiment, but alternatively may be halogenic acid, perhalogenic acid, halogenous acid, and the like. Hypohalous acid is preferably used due to stability. Hypohalous acid is hypobromate acid in the present embodiment, but alternatively may be hypochlorous acid or hypoiotic acid. Substances that can be measured by a typical residual chlorine meter, such as combined chlorine or combined bromine, may also be used instead of halogen oxoacid, but halogen oxoacid is preferable in view of its efficiency in removing urea. Means for adding halogen oxoacid 21 include storage tank 21a for bromide salt (means for supplying bromide salt), storage tank 21b for an oxidizing agent (means for supplying an oxidizing agent), residence tank 21c for the bromide salt and the oxidizing agent (means for mixing the bromide salt and the oxidizing agent), and transfer pump 21d. Examples of the bromide salt include sodium bromide (NaBr) and potassium bromide. Examples of the oxidizing agent include hypochlorite (for example, sodium hypochlorite (NaClO)), permanganate, hydrogen peroxide, and persulfate. Since hypobromate acid is difficult to keep for a long time, hypobromate acid is produced by mixing bromide salt with an oxidizing agent at the time when hypobromate acid is to be used. Hypobromate acid that is produced in residence tank 21c is pressurized by transfer pump 21d and is added to the water to be treated that flows in main line L1. Alternatively, bromide salt and an oxidizing agent may be directly supplied to main line L1 such that they are agitated by the flow of the water to be treated in main line L1 to thereby produce hypobromate acid. Hypobromate acid may be continuously or intermittently added to the water to be treated. Alternatively, a line mixer or an orifice may be provided on main line L1 in order that these devices create turbulence to mix bromide salt with the oxidizing agent and thereby produce hypobromate acid. Only one kind of halogen oxoacid may be added, or a mixture of two kinds or more of halogen oxoacid may be added.

The mass concentration of the halogen oxoacid may be 6 to 200 times, and more preferably 30 times or more, than the TOC (Total Organic Carbon) in the water to be treated. Adding a mass concentration of halogen oxoacid of 200 times or more than the TOC increases burden on downstream apparatuses. As will be shown in Example 5 (to be described later), depending on the requirements of water quality, urea may be sufficiently removed by adding a six times mass concentration of halogen oxoacid. Furthermore, as will be described in Example 4, the concentration of divalent anions that are contained in the water to be treated is preferably in the range of from 0 to 0.4 mmol/L. Note that the concentration of halogen oxoacid, the TOC, and the concentration of divalent anions in the water to be treated are defined at the inlet of ion exchanger loaded apparatus 14.

The connection of means for adding halogen oxoacid 21 to main line L1, that is, the point at which halogen oxoacid is added to the water to be treated, is positioned between first ion exchanger apparatus 13 and ion exchanger loaded apparatus 14. Specifically, ion exchanger loaded apparatus 14 is positioned immediately downstream of the connection of means for adding halogen oxoacid 21 to main line L1, and the water to be treated to which the halogen oxoacid has been added is immediately treated by ion exchanger loaded apparatus 14. “Immediately downstream” means that no water treatment apparatus having a water contacting portion that is made of organic materials is provided between the addition point of means for adding halogen oxoacid 21 and ion exchanger loaded apparatus 14. Water treatment apparatuses are every kind of apparatus for removing impurities that are contained in the water to be treated and include filter membranes (such as reverse osmosis membranes, ultrafiltration membranes, and microfiltration membranes), ion exchanger apparatuses, deaerator apparatuses, and the like, but do not include heat exchangers, pumps, valves, measuring instruments, or the like.

Ion exchanger loaded apparatus 14 is a tower in which at least anion exchangers are loaded. Cation exchangers may be further loaded in ion exchanger loaded apparatus 14. In this case, the cation exchangers and the anion exchangers are loaded either in a mixed bed or in a dual bed, and in the case of the latter, the anion exchangers are preferably arranged upstream of the cation exchangers. As will be described later in Example 1, it is more preferable that only anion exchangers be loaded in ion exchanger loaded apparatus 14 in view of their efficiency in removing urea. On the other hand, when the cation exchangers and the anion exchangers are loaded in a mixed bed, positively charged eluting materials that elute from the anion exchangers can be absorbed by the cation exchangers. Anion exchanger resins and cation exchanger resins are preferably used as anion exchangers and cation exchangers, but anion exchangers and cation exchangers of a monolithic-type or a fibrous-type may also be used. Ion exchanger resins may be either of the gel-type or MR type. The types of anion exchanger resins are not limited, and the anion exchanger resins may be either strongly basic resins or weakly basic resins. When the anion exchanger resins are strongly basic resins, the anion exchanger resins may be of the OH-type, the Cl-type, and the like. Alternatively, ion exchanger loaded apparatus 14 may be an electro-deionization apparatus (EDI) in which anion exchanger resins are loaded.

Urea can be efficiently removed in a short time by allowing the water to be treated to which halogen oxoacid has been added to come into contact with anion exchangers that are loaded in ion exchanger loaded apparatus 14. Most of the urea is removed in several seconds to several minutes during which the water to be treated passes through ion exchanger loaded apparatus 14. Urea can be removed in an extremely short time as compared to a conventional reaction tank that needs an order of several hours of residence time. In addition, a conventional reaction tank needs large dimensions in order to ensure enough residence time for the water to be treated. Ion exchanger loaded apparatus 14 is constructed in the same manner as a typical ion exchanger apparatus and is therefore more advantageous than a reaction tank in view of footprint.

As to why the inventors believe that urea is efficiently removed in a short time by allowing the water to be treated, to which halogen oxoacid and especially hypohalous acid has been added, to come into contact with anion exchangers, when halogen oxoacid comes into contact with anion exchangers, halogen oxoacid ions are captured by anion exchangers. As a result, halogen oxoacid ions are concentrated in the anion exchangers. In addition, the water to be treated flows in spaces in the anion exchangers (gaps between the resins in the case of resins) and the urea is thus easily kept in the anion exchangers. For these reasons, halogen oxoacid ions are more likely to come into contact with urea and the urea can be removed in a short time. Accordingly, ion exchanger loaded apparatus 14 requires at least anion exchangers to be loaded therein in order to capture halogen oxoacid ions.

Means for adding reducing agent 22 is provided between ion exchanger loaded apparatus 14 and reverse osmosis membrane apparatus 15. Means for adding reducing agent 22 removes remaining halogen oxoacid in the water to be treated. Hydrogen peroxide is used as the reducing agent but sulfite may also be used. Means for adding reducing agent 22 includes storage tank 22a for the reducing agent and transfer pump 22b. The reducing agent is pressurized by transfer pump 22b and is added to the water to be treated that flows in main line L1 at a position between ion exchanger loaded apparatus 14 and reverse osmosis membrane apparatus 15. The means for removing halogen oxoacid is not limited to means for adding reducing agent 22 as long as the means for removing halogen oxoacid has the same effect. For example, carriers for platinum group metal catalysts such as palladium (Pd), activated carbon, and the like may be used. Alternatively, these means for removing halogen oxoacid may be combined in a series.

Reverse osmosis membrane apparatus 15 removes excessive reducing agent. Means for removing reducing agent may be ion exchanger resins, an electro-deionization apparatus, an ultraviolet ray radiating apparatus, carriers that carry platinum group metal catalysts, and the like, and these means for removing reducing agent may be combined in a series. The carriers for platinum group metal catalysts are anion exchanger resins that carry platinum group metal catalysts that consist of a platinum group metal. As the anion exchangers, anion exchanger resins and monolithic-type organic porous anion exchangers may be used. The platinum group metal catalysts use their catalyzing function to decompose reducing agents such as hydrogen peroxide. Platinum group metals include platinum (Pt), palladium (Pd), ruthenium (Ru), rhodium (Rh), osmium (Os), iridium (Ir), and the like. Only one of these metals may be used, or a combination of two or more of these metals may be used. Among these platinum group metals, Pt and Pd are preferable, and Pd is more preferable in view of cost. The position of the carriers for the platinum group metal catalyst is not particularly limited as long as it is positioned downstream of the point at which the reducing agent is added but is preferably downstream of second ion exchanger apparatus 17, described later. Since anion components are removed by second ion exchanger apparatus 17, the performance of platinum group metal catalysts is improved in removing reducing agent.

Ultraviolet ray radiating apparatus 16 radiates ultraviolet rays to the water to be treated. Ultraviolet ray radiating apparatus 16 may have an ultraviolet ray lamp that includes, for example, a wavelength of at least any one of 254 nm, 185 nm, and 172 nm. Anion exchangers (and cation exchangers) that are loaded in ion exchanger loaded apparatus 14 are degraded by coming into contact with halogen oxoacid that works as an oxidizing agent and allow organic materials to flow into the water to be treated. The organic materials are decomposed by reverse osmosis membrane apparatus 15, ultraviolet ray radiating apparatus 16, and second ion exchanger apparatus 17 (cation exchangers). Description will now be given in detail regarding this point.

Halogen oxoacid such as hypobromate acid easily degrades, for example, a membrane that is made of organic materials due to its strong oxidizing effect. Therefore, it is essentially undesirable to allow halogen oxoacid to come into contact with organic structures such as anion exchangers as in the present embodiment, because the water quality of the water to be treated readily deteriorates due to organic materials that are detached. However, the inventors found that urea can be removed highly efficiently and in a short time by allowing the water to be treated to which halogen oxoacid has been added to come into contact with anion exchangers. Thus, despite the problem that organic materials are more likely to be detached, the water to be treated to which halogen oxoacid has been added nevertheless comes into contact with anion exchangers in the present embodiment. In addition, reverse osmosis membrane apparatus 15, ultraviolet ray radiating apparatus 16, and second ion exchanger apparatus 17 are provided for subsequent processes of removing organic materials that may be thus generated.

Alternatively, the following explanation is also possible. In the present embodiment, anion exchangers are essential for removing urea, and therefore, the anion exchangers in ion exchanger loaded apparatus 14 are forced to come into contact with halogen oxoacid. However, other water treatment apparatuses (such as organic membranes) having a water contacting portion that is made of organic materials do not contribute or only slightly contribute to the removal of urea when they come into contact with halogen oxoacid. In addition, the capability to treat other components deteriorates due to degradation of the organic material by contact with halogen oxoacid. For this reason, these water treatment apparatuses are arranged downstream of ion exchanger loaded apparatus 14 in order to prevent these apparatuses from coming into contact with highly concentrated halogen oxoacid. Specifically, in the present embodiment, no water treatment apparatus that has a water contacting portion that is made of organic materials and that comes into contact with the water to be treated to which halogen oxoacid is added is provided between the point at which halogen oxoacid is added to the water to be treated and ion exchanger loaded apparatus 14. The concentration of halogen oxoacid in the water to be treated is greatly decreased downstream of ion exchanger loaded apparatus 14 because halogen oxoacid is consumed by ion exchanger loaded apparatus 14 and is decomposed by the reducing agent. As a result, downstream of ion exchanger loaded apparatus 14, and especially downstream of means for adding reducing agent 22, the deterioration of water quality caused by organic materials that are detached or organic materials that are elute from each water treatment apparatus is limited, if present at all. In summary, in the present embodiment, water treatment apparatuses that have a water contacting portion that is made of organic materials and that comes into contact with halogen oxoacid is limited to an apparatus essential for removing urea, and as a result, both an improvement in the efficiency in removing urea and a limitation of organic materials that flow out are achieved.

Second ion exchanger apparatus 17 that is positioned downstream of ultraviolet ray radiating apparatus 16 is a regenerative ion exchanger resin tower in which anion exchanger resins and cation exchanger resins are loaded. Decomposition products of organic materials that are generated in the water to be treated by the radiation of ultraviolet rays are removed by second ion exchanger apparatus 17. Dissolved oxygen, carbonic acid, and the like in the water to be treated are then removed by deaerator apparatus 18.

Apparatuses for producing pure water according to other embodiments of the present invention will next be described with reference to FIGS. 2 to 7. The arrangement and the effect that are the same as those of the first embodiment will not be described here. As will be understood from the second to sixth embodiments, means for adding halogen oxoacid 21 and ion exchanger loaded apparatus 14 are incorporated into the apparatuses for producing pure water as an inseparable set, and this set may be provided at various positions.

### Second Embodiment

FIG. 2 schematically illustrates the arrangement of apparatus for producing pure water 1B according to the second embodiment of the present invention. Halogen oxoacid is added to the treated water of activated carbon tower 12. Thus, ion exchanger loaded apparatus 14 is provided between the point at which halogen oxoacid is added and first ion exchanger apparatus 13. Specifically, activated carbon tower 12, the point at which halogen oxoacid is added, ion exchanger loaded apparatus 14, the point at which a reducing agent is added, and first ion exchanger apparatus 13 are arranged on main line L1 in a series from upstream to downstream in flow direction D of the water to be treated in the order mentioned above. In addition, in the present embodiment, no water treatment apparatus having a water contacting portion that is made of organic materials is provided between the point at which halogen oxoacid is added and ion exchanger loaded apparatus 14, and the water quality of the water to be treated is thereby prevented from deteriorating due to the detachment or elution of organic materials. In addition, components that originate from the oxidizing agent (bromide ions, chloride ions, and Na ions in the present embodiment) and components that originate from the reducing agent can be removed not only by reverse osmosis membrane apparatus 15 and second ion exchanger apparatus 17 but also by first ion exchanger apparatus 13. Accordingly, the burden on the water treatment apparatuses downstream of first ion exchanger apparatus 13 can be mitigated.

### Third Embodiment

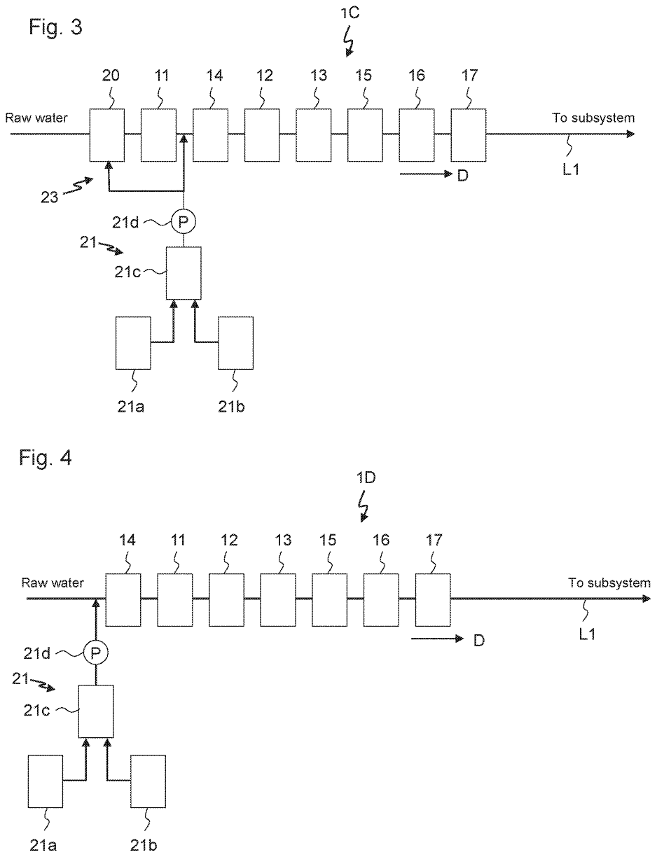

FIG. 3 schematically illustrates the arrangement of apparatus for producing pure water 1C according to the third embodiment of the present invention. Halogen oxoacid is added at two points, that is, upstream and downstream of filter apparatus 11. Specifically, means for adding halogen oxoacid 21 is connected to a point downstream of filter apparatus 11. Reaction tank 20 is provided upstream of filter apparatus 11, and additional means for adding halogen oxoacid 23 is connected to reaction tank 20. Although not illustrated, additional means for adding halogen oxoacid 23 may alternatively be connected to a point upstream of reaction tank 20. Means for adding halogen oxoacid 21 and additional means for adding halogen oxoacid 23 share storage tanks 21a and 21b, residence tank 21c, and transfer pump 21d, but these apparatuses may be provided separately for means for adding halogen oxoacid 21 and additional means for adding halogen oxoacid 23. Halogen oxoacid is added to the water to be treated for reaction tank 20, and the water to be treated stays in reaction tank 20 for a predetermined time before it is suppled to filter apparatus 11. Although water to be treated that is supplied to filter apparatus 11 contains highly concentrated halogen oxoacid, filter apparatus 11 is not degraded by the contact with halogen oxoacid because filter apparatus 11 is a sand filter apparatus. In addition, halogen oxoacid can be removed by activated carbon tower 12, whereby means for adding reducing agent 22 becomes unnecessary.

Reaction tank 20 has substantially the same arrangement as a conventional reaction tank. Specifically, reaction tank 20 has an inner flow channel (not illustrated) and removes urea while the water to be treated flows along the flow channel for a predetermined time. However, it is not necessary to completely remove urea by reaction tank 20 because halogen oxoacid is added again to the water to be treated after it flows out of reaction tank 20 in the present embodiment. In general, the efficiency of removing urea tends to decrease as the concentration of urea decreases. For example, reducing the concentration of urea from the initial concentration to 10% takes about the same time as reducing the concentration of urea from 10% to 1%. Reaction tank 20 is only required to roughly remove urea in the present embodiment and therefore does not require a long residence time. Accordingly, it is possible to treat urea in a short time as compared to a conventional method and it is also possible to reduce the size of reaction tank 20. On the other hand, the amount of urea to be treated by ion exchanger loaded apparatus 14 is greatly reduced by reaction tank 20, and the burden on ion exchanger loaded apparatus 14 is thereby reduced. Thus, the anion exchangers (and the cation exchangers) can be replaced less frequently, and the amount of organic materials that are generated by the degraded anion exchangers (and cation exchangers) is also reduced. Means for adding halogen oxoacid 21 of the present embodiment is connected to main line L1 at the outlet of filter apparatus 11. However, the connection of means for adding halogen oxoacid 21 is not limited to this form, and means for adding halogen oxoacid 21 may be connected to main line L1 at one of the positions used in the other embodiments.

Reaction tank 20 may be omitted. In addition, only one of means for adding halogen oxoacid 21 or additional means for adding halogen oxoacid 23 may be provided or both means may be provided. For example, when reaction tank 20 is provided and only additional means for adding halogen oxoacid 23 is provided as means for adding halogen acid, it is possible to allow halogen oxoacid that has not been consumed by reaction tank 20 to come into contact with anion exchangers that are loaded in ion exchanger loaded apparatus 14. In addition, in the present embodiment, components that originate from the oxidizing agent and components that originate from the reducing agent can be removed by first ion exchanger apparatus 13, as in the second embodiment.

### Fourth Embodiment

FIG. 4 schematically illustrates the arrangement of apparatus for producing pure water 1D according to the fourth embodiment of the present invention. Halogen oxoacid is added upstream of filter apparatus 11. Thus, ion exchanger loaded apparatus 14 is provided between the point at which halogen oxoacid is added and filter apparatus 11. Specifically, the point at which halogen oxoacid is added, ion exchanger loaded apparatus 14, filter apparatus 11, activated carbon tower 12, and first ion exchanger apparatus 13 are arranged on main line L1 in a series from upstream to downstream in the flow direction D of the water to be treated in the order mentioned above. As described above, filter apparatus 11 is less likely to be affected by halogen oxoacid because filter apparatus 11 is a sand filter apparatus. Accordingly, filter apparatus 11 may also be provided between the point at which halogen oxoacid is added and ion exchanger loaded apparatus 14. In the present embodiment, when a small number of fractured materials flow out from the anion exchangers of ion exchanger loaded apparatus 14, the fractured materials can be removed by downstream filter apparatus 11. In addition, means for adding reducing agent 22 is not needed because halogen oxoacid can be removed by activated carbon tower 12. In the present embodiment, reaction tank 20 may be provided upstream of ion exchanger loaded apparatus 14, as in the third embodiment. In addition, in the present embodiment, components that originate from the oxidizing agent and components that originate from the reducing agent can be removed by first ion exchanger apparatus 13, as in the second embodiment.

### Fifth Embodiment

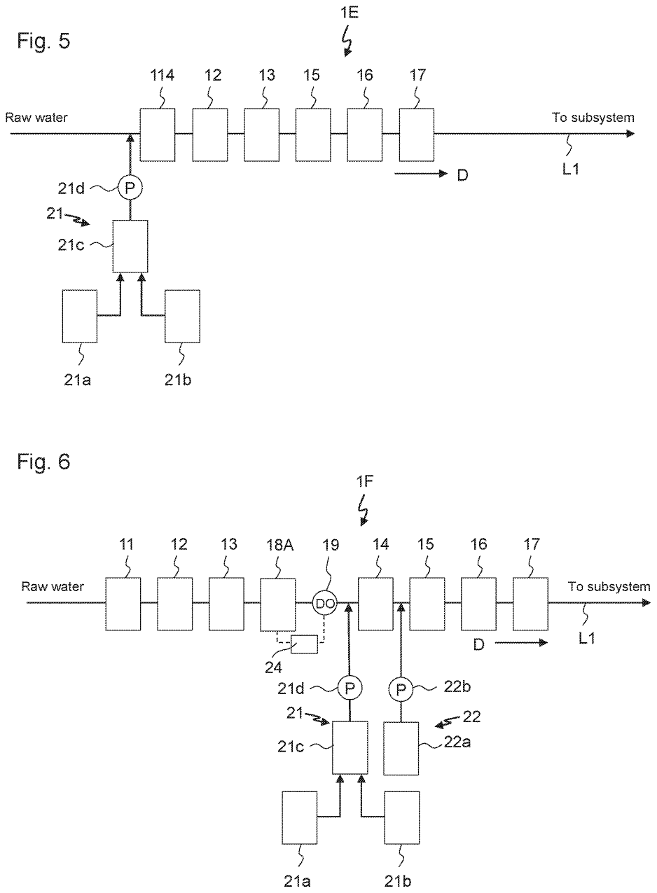

FIG. 5 schematically illustrates the arrangement of apparatus for producing pure water 1E according to the fifth embodiment of the present invention. The filter apparatus is integral with ion exchanger loaded apparatus 114. Specifically, sand and ion exchangers are loaded in a common tower in a dual bed or in a mixed bed. Both cost and footprint of the apparatus can be reduced in the present embodiment. In addition, in the present embodiment, components that originate from the oxidizing agent and components that originate from the reducing agent can be removed by first ion exchanger apparatus 13, as in the second embodiment. Means for adding reducing agent 22 is not needed because halogen oxoacid can be removed by activated carbon tower 12.

### Sixth Embodiment

FIG. 6 schematically illustrates the arrangement of apparatus for producing pure water 1F according to the sixth embodiment of the present invention. Apparatus for producing pure water 1F of the present embodiment includes means for adjusting dissolved oxygen (deoxygenation apparatus 18A and dissolved oxygen meter 19). Deoxygenation apparatus 18A is provided upstream of means for adding halogen oxoacid 21, that is, between first ion exchanger apparatus 13 and ion exchanger loaded apparatus 14. The point at which halogen oxoacid is added is provided between deoxygenation apparatus 18A and ion exchanger loaded apparatus 14. Deoxygenation apparatus 18A adjusts the concentration of dissolved oxygen in the water to be treated to 0.1 mg/L or more and 1 mg/L or less at the inlet of ion exchanger loaded apparatus 14. Dissolved oxygen meter 19 is provided between deoxygenation apparatus 18A and ion exchanger loaded apparatus 14. Dissolved oxygen meter 19 measures the concentration of dissolved oxygen in the water to be treated at the outlet of deoxygenation apparatus 18A. The concentration of dissolved oxygen that is measured by dissolved oxygen meter 19 is sent to control unit 24 of deoxygenation apparatus 18A. Control unit 24 controls deoxygenation apparatus 18A based on this concentration of dissolved oxygen such that the concentration of dissolved oxygen that is measured by dissolved oxygen meter 19 is 0.1 mg/L or more and 1 mg/L or less. As a result, the concentration of dissolved oxygen in the water to be treated is controlled to 1 mg/L or less at the inlet of ion exchanger loaded apparatus 14.

Deoxygenation apparatus 18A, which is the same as or similar to deaerator apparatus 18 in the first to fifth embodiments, removes oxygen from the water to be treated and thereby reduces the concentration of dissolved oxygen in the water to be treated. Therefore, deaerator apparatus 18 is omitted in the present embodiment but may be provided at the same position as in the first to fifth embodiments. The kind of deoxygenation apparatus 18A is not limited and, for example, a vacuum deaerator apparatus may be used. In a typical vacuum deaerator apparatus, a gas-liquid contact element for increasing the surface area of water is loaded in the deaeration tower and the deaeration tower is depressurized by a vacuum pump such that pure water, that is water to be treated, is placed in a vacuum to remove dissolved oxygen. The concentration of dissolved oxygen can be controlled by adjusting the degree of vacuum in the deaeration tower by means of the vacuum pump. In addition, deaeration performance can be improved by introducing nitrogen. In this case, the concentration of dissolved oxygen can be controlled by adjusting the degree of vacuum and the amount of introduced nitrogen (the partial pressure of nitrogen). A deoxygenation apparatus having a deaeration membrane may also be used. In this case, a vacuum pump is used as in the vacuum deaerator apparatus, and the concentration of dissolved oxygen can be controlled by adjusting the degree of vacuum. Two or more deoxygenation apparatuses 18A may be provided in a series. As alternative deoxygenation apparatus 18A, an arrangement may be used in which hydrogen (H₂) is added to the water to be treated and the water to be treated comes into contact with palladium (Pd) catalysts. Oxygen reacts with hydrogen to produce water with the aid of the palladium catalysts and oxygen can thereby be removed.

Resins that are loaded in ion exchanger loaded apparatus 14 are water contacting portions that are made of organic materials. Therefore, when an oxidizing agent such as halogen oxoacid comes into contact with such water contacting portions, the resins, or the water contacting portions, are oxidized and degraded, and the water quality of the treated water deteriorates. In addition, the resins that are oxidized and degraded swell and thereby increase the pressure loss of the water. The inventors found that concentrations of dissolved oxygen in excess of 1 mg/L promote oxidization by the oxidizing agent and causes degradation of the water quality and an increase in the pressure loss of the water. The oxidizing force of the oxidizing agent is reduced and the oxidization and the deterioration of the resins can be mitigated by adjusting the concentration of dissolved oxygen in the water to be treated to 1 mg/L or less. The lower limit of the concentration of dissolved oxygen in the water to be treated is not particularly limited but is preferably 0.1 mg/L or more. When the concentration of dissolved oxygen is less than 0.1 mg/L, the effect of preventing the oxidization and the deterioration of the water contacting portions is small and limited, if any. In addition, lowering the concentration of dissolved oxygen to below 0.1 mg/L disadvantageously increases the size and the operation cost of the vacuum pump of deoxygenation apparatus 18A.

Although some embodiments have been described, the apparatus for producing pure water of the present invention is not limited to these embodiments. For example, first ion exchanger apparatus 13 may be omitted and an EDI may be provided between reverse osmosis membrane apparatus 15 and ultraviolet ray radiating apparatus 16 in the first to the sixth embodiments. In addition, a plurality of reverse osmosis membrane apparatuses 15 may be provided in tandem or in a series in each embodiment described above. In this case, means for adding halogen oxoacid 21, ion exchanger loaded apparatus 14, and means for adding reducing agent 22 may be provided in the order mentioned above between an upstream reverse osmosis membrane apparatus and a downstream reverse osmosis membrane apparatus. The position of means for adjusting dissolved oxygen (deoxygenation apparatus 18A and dissolved oxygen meter 19) is not particularly limited in the sixth embodiment. For example, a plurality of reverse osmosis membrane apparatuses 15 may be provided in a series and means for adjusting dissolved oxygen, means for adding halogen oxoacid 21, ion exchanger loaded apparatus 14, and means for adding reducing agent 22 may be provided between reverse osmosis membrane apparatuses 15. In other words, another reverse osmosis membrane apparatus 15 may be provided between first ion exchanger apparatus 13 and deoxygenation apparatus 18A in FIG. 6. In this case, first ion exchanger apparatus 13 may be omitted.

In addition, for example, means for adding halogen oxoacid 21, ion exchanger loaded apparatus 14, and means for adding reducing agent 22 may be provided downstream of reverse osmosis membrane apparatus 15. Second ion exchanger apparatus 17 may be an electro-deionization apparatus (EDI). Furthermore, the present invention may also be used for the treatment of collected water or drained water.

### Seventh Embodiment

The technical concept that is shown in the sixth embodiment can be extended to a water treatment system in which an oxidizing agent that contains halogen oxoacid or an oxidizing agent other than halogen oxoacid is added to the water to be treated. Specifically, typical water treatment apparatuses (reverse osmosis membranes, ion exchanger resins, and the like) that are used in a water treatment system are oxidized and degraded by an oxidizing agent that is introduced into the apparatuses, and treatment performance is thereby significantly degraded. Therefore, means such as an activated carbon tower for removing an oxidizing agent is typically provided upstream of the water treatment apparatus or downstream of the point at which the oxidizing agent is added to the water to be treated. However, aged activated carbon degrades the performance of removing an oxidizing agent and allows the oxidizing agent to flow into downstream water treatment apparatuses. In addition, activated carbon itself may be degraded due to oxidization and may elute organic materials, and the materials may work as a burden on downstream apparatuses, degrade the downstream water treatment apparatuses and the water quality of pure water. In addition, a sterilizer (an oxidizing agent) may be supplied to a water treatment apparatus in order to sterilize the water treatment apparatus to a level that does not damage the water treatment apparatus. However, depending on conditions, the water treatment apparatus may be degraded and oxidized by the sterilizer. The method of removing an oxidizing agent by adding a reducing agent is less likely to cause aging degradation of apparatuses, unlike an activated carbon tower, but residual reducing agent may become a burden on the downstream water treatment apparatuses. In an advanced oxidation process (AOP) that uses an oxidizing agent, residual oxidizing agent may also degrade resins in downstream water treatment apparatuses.

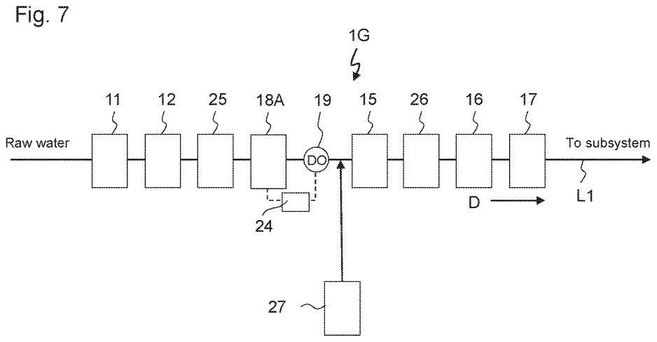

FIG. 7 schematically illustrates the arrangement of apparatus for producing pure water 1G according to the seventh embodiment of the present invention. In the present embodiment, softening apparatus 25 is provided instead of first ion exchanger apparatus 13 of the sixth embodiment. In addition, means for adding oxidizing agent 27 that is more general than adding halogen oxoacid 21 is provided instead of means for adding halogen oxoacid 21. Softening apparatus 25 is an apparatus for removing hardness components, such as calcium and magnesium, and typically has ion exchanger resins loaded therein. Softening apparatus 25 is provided upstream of reverse osmosis membrane apparatus 15 because the oxidization and the degradation of reverse osmosis membrane apparatus 15 by components such as residual chlorine are typically promoted by the presence of hardness components. The position of softening apparatus 25 is not limited as long as it is positioned upstream of reverse osmosis membrane apparatus 15. EDI 26 is provided between reverse osmosis membrane apparatus 15 and ultraviolet ray radiating apparatus 16. When the oxidizing agent leaks into the treated water of reverse osmosis membrane apparatus 15, treated water that contains the oxidizing agent is supplied to EDI 26. However, since the concentration of dissolved oxygen in the water to be treated is adjusted to 1 mg/L or less by deoxygenation apparatus 18A, the oxidization and the deterioration of the resins that are loaded in EDI 26 are limited and stable water quality of the treated water can be thereby obtained. It should be noted that softening apparatus 25 and EDI 26 are not essential in the present embodiment. Although not illustrated, an apparatus for producing pure water may include filter device 11, activated carbon tower 12, first ion exchanger apparatus 13, deoxygenation apparatus 18A, dissolved oxygen meter 19, reverse osmosis membrane apparatus 15, ultraviolet ray radiating apparatus (ultraviolet ray oxidization apparatus) 16, second ion exchanger apparatus 17, and deaerator apparatus 18, and these apparatuses may be arranged in the order mentioned above. Means for adding oxidizing agent 27 may be provided between dissolved oxygen meter 19 and reverse osmosis membrane apparatus 15.

Accordingly, a water treatment system comprises: a water treatment apparatus having a water contacting portion that is made of organic materials; means for adding an oxidizing agent that is positioned upstream of the water treatment apparatus and that adds an oxidizing agent to the water to be treated; and a deoxygenation apparatus that is positioned upstream of the water treatment apparatus and that adjusts the concentration of dissolved oxygen to 1 mg/L or less at the inlet of the water treatment apparatus. Examples of the water treatment apparatuses include a reverse osmosis membrane apparatus and an ion exchanger apparatus or an EDI each having ion exchanger resins loaded therein. In addition, a water treatment method comprises: adding an oxidizing agent to the water to be treated by using means for adding oxidizing agent upstream of a water treatment apparatus having a water contacting portion that is made of organic materials; and adjusting the concentration of dissolved oxygen to 1 mg/L or less at the inlet of the water treatment apparatus by using a deoxygenation apparatus that is positioned upstream of the water treatment apparatus. The oxidizing agent is not limited to halogen oxoacid such as hypohalogenous acid and may be permanganate, hydrogen peroxide, persulfate, and the like or may be bactericide that is used for a water treatment apparatus. The water to be treated may contain free chlorine, combined chlorine, combined bromine, and the like.

In addition, the present invention is applicable to an arrangement that does not have means for adding oxidizing agent 27 and in which an oxidizing agent is not added by means for adding oxidizing agent 27 but water to be treated contains an oxidizing agent. Alternatively, means for adding halogen oxoacid 21 and means for adding reducing agent 22 may be omitted in the sixth embodiment. In this case, the oxidization and deterioration of reverse osmosis membrane apparatus 15 and ion exchanger resins loaded in EDI 26 are limited by means for adjusting dissolved oxygen (deoxygenation apparatus 18A and dissolved oxygen meter 19).

Accordingly, a water treatment system comprises: a water treatment apparatus to which water to be treated that contains an oxidizing agent is supplied and that has a water contacting portion that is made of organic materials; and a deoxygenation apparatus that is positioned upstream of the water treatment apparatus and that adjusts the concentration of dissolved oxygen in the water to be treated to 1 mg/L or less at the inlet of the water treatment apparatus. In addition, a water treatment method comprises: supplying water to be treated that contains an oxidizing agent to a water treatment apparatus having a water contacting portion that is made of organic materials; and adjusting the concentration of dissolved oxygen in the water to be treated to 1 mg/L or less at the inlet of the water treatment apparatus.

### Example 1

Water to be treated that was produced by adding halogen oxoacid to ultrapure water was supplied to a column that simulated an ion exchanger apparatus and the removal rate of urea was measured. A quantity of 100 mL of ion exchanger resins was loaded into the column and water to be treated was supplied at a flow rate of 12 L/h (SV120(/h)). The amount of added urea was adjusted such that the concentration of urea was 80 μg/L. Hypobromate acid was added as the halogen oxoic acid at a concentration of 2 mg-Cl₂/L (chlorine equivalent concentration). NaBr was selected as a bromide salt, NaClO was selected as an oxidizing agent, and hypobromate acid was produced by mixing NaBr with NaClO. The concentration of hypobromous acid was measured by a free chlorine reagent and a salt content meter (manufactured by HANNA) after adding glycine to the sample water to convert free chlorine into combined chlorine. In Comparative Example 1, 100 mL of cation exchanger resins was loaded only in the column. In Example 1-1, 100 mL of anion exchanger resins was loaded only in the column. In Example 1-2, a total of 100 mL of anion exchanger resins and cation exchanger resins were loaded in the column in a mixed bed with a volume ratio of 2:1. AMBERJET 1024 H (manufactured by Organo Corporation) was used as the cation exchanger resins and AMBERJET 4002 OH (manufactured by Organo Corporation) was used as the anion exchanger resins. The removal rate of urea was calculated as (C1−C2)/C1×100(%), where C1 is the concentration of urea in the water to be treated at the inlet of the column and C2 is the concentration of urea in the treated water of the column. The concentration of urea was measured by an ICP-MS (Inductively Coupled Plasma Mass Spectrometry) apparatus. The removal rate of urea was 98% in Example 1-1, 95% in Example 1-2, and 0.5% in Comparative Example 1. Thus, it was found that urea could be efficiently removed by allowing the water to be treated that contained hypobromate acid to come into contact with anion exchangers.

### Example 2

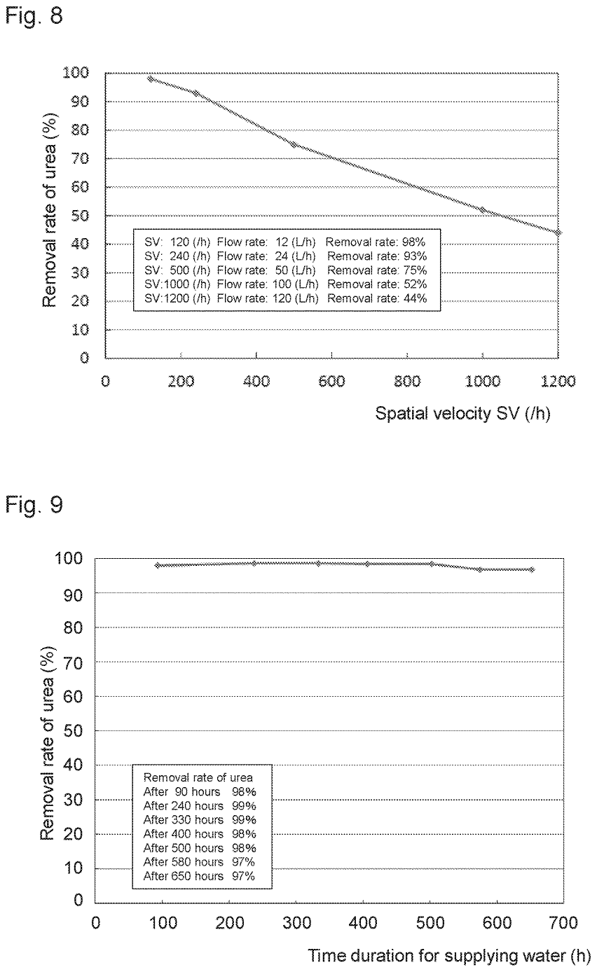

The removal rate of urea was obtained using the same apparatus as in Example 1 for various spatial velocities at which the water to be treated was supplied to the column. Specifically, the removal rate of urea was obtained for a plurality of SVs (120, 240, 500, 1000, 1200) (unit (/h)) under the conditions of Example 1-1. The amount of added anion exchanger resins was set to 100 mL for each SV and the flow rate of the water to be treated was changed. FIG. 8 shows the relationship between the SV and removal rate of urea. As the SV decreased, the removal rate of urea was improved because the water to be treated was kept in contact with the anion exchangers for a longer time. The removal rate of urea decreased as the SV increased, but the removal rate of 44% was obtained even when the SV was 1200(/h). The removal rate of this level may be sufficiently effective depending on the requirements of water quality. Accordingly, it is preferable that the water to be treated be supplied to ion exchanger loaded apparatus 14 at a spatial velocity SV of 1200(/h) or less, with SV of 500(/h) or less being preferable in order to obtain a removal rate of urea of 70% or more, and SV of 240(/h) or less being preferable in order to obtain a removal rate of urea of 90% or more.

### Example 3

The relationship between the removal rate of urea and the time duration over which the water to be treated was supplied to ion exchanger loaded apparatus 14 was obtained using the same apparatus as in Example 1. Specifically, water to be treated was prepared by adding urea and hypochlorous acid to ultrapure water under the same conditions as in Example 1-1. The water to be treated was supplied at a flow rate of 120 L/h until the accumulated amount of BrO⁻ reached about twice the equivalent of the ion exchanger capacity of the anion exchanger resins (the water was supplied for about 700 hours). FIG. 9 shows the relationship between the time duration over which the water was supplied and the removal rate of urea. The anion exchanger resins that were used, which were non-regenerative, maintained a good removal rate of urea when the water was supplied for a long time. Accordingly, use of ion exchanger loaded apparatus 14 of a non-regenerative type enables a long-time operation without requiring a regeneration process.

### Example 4

The relationship between the removal rate of urea and the concentration of sulfate ion in the water to be treated was obtained using the same apparatus as in Example 1. Specifically, 100 mL of ion exchanger resins was loaded into the column in the same manner as in Example 1-1 and the water to be treated was supplied at a flow rate of 12 L/h (SV120(/h)). The amount of added urea was adjusted such that the concentration of urea was 80 μg/L. Hypobromate acid was added as halogen oxoacid at a concentration of 2 mg-Cl₂/L (chlorine equivalent concentration). Then, sulfuric acid was added to the water to be treated. Accordingly, divalent anions (SO₄²⁻) were contained in the water to be treated. Table 1 shows the results. As the concentration of divalent anions increased, the removal rate of urea decreased. This is because halogen oxoacid was less likely to be captured by the resins when divalent anions coexisted. However, the removal rate of urea of 36% may be sufficiently effective depending on the requirements of water quality. Accordingly, the concentration of divalent anions that are contained in the water to be treated is preferably 0.4 mmol/L or less, and more preferably 0.1 mmol/L or less.

TABLE 1

| | Concentration of sulfate ion | Removal rate of urea |
|---|---|---|
| | (mmol/L) | (%) |
| Example 4-1 | 0.001 | 98 |
| Example 4-2 | 0.01 | 74 |
| Example 4-3 | 0.1 | 54 |
| Example 4-4 | 0.2 | 51 |
| Example 4-5 | 0.4 | 36 |

### Example 5

The relationship between the removal rate of urea and the ratio (mass ratio) of the concentration of halogen oxoacid to the TOC in the water to be treated was obtained using the same apparatus as in Example 1. Specifically, 100 mL of ion exchanger resins was loaded into the column in the same manner as in Example 1-1 and the water to be treated was supplied at a flow rate of 12 L/h (SV120(/h)). The amount of added urea was adjusted such that the concentration of urea was 80 μg/L. Hypobromate acid was added as halogen oxoacid at a concentration of 2 mg-Cl₂/L (chlorine equivalent concentration). Table 2 shows the results. “Ratio of hypobromate acid to the TOC” in the table means the ratio of the concentration of halogen oxoacid to the TOC. As the ratio of hypobromate acid to the TOC increased, the removal rate of urea was improved. However, the removal rate of urea of 50% may be sufficiently effective depending on the requirements of water quality. Accordingly, the ratio of the mass concentration of halogen oxoacid to the TOC in the water to be treated is preferably 6 or more, and more preferably 30 or more. In addition, the ratio of the mass concentration of halogen oxoacid to the TOC is preferably 200 or less in order to limit the influence on the downstream apparatuses, as described above. The TOC in this example was a concentration of urea that was converted into the TOC.

TABLE 2

| | Ratio of Hypobromate to TOC | Removal rate of urea |
|---|---|---|
| | (mass ratio) | (%) |
| Example 5-1 | 6 | 50 |
| Example 5-2 | 30 | 90 |
| Example 5-3 | 130 | 98 |

### Example 6

The relationship between the concentration of dissolved oxygen and the pressure loss of the resins, and the relationship between the concentration of dissolved oxygen and the TOC were obtained using the same apparatus as in Example 1. Specifically, water to be treated that was prepared by adding halogen oxoacid to pure water was supplied to the column at a flow rate of 12 L/h (SV120(/h)) under the same conditions as in Example 1-1 and the removal rate of urea was measured. The amount of added urea was adjusted such that the concentration of urea was 80 μg/L. Hypobromate acid was added as hypohalogous acid at a concentration of 2 mg-Cl₂/L (chlorine equivalent concentration). An increase in the pressure loss of the supplied water and an increase in the TOC were measured for various concentrations of dissolved oxygen in the water to be treated after the water to be treated was supplied for 250 hours. The TOC that originated from urea was subtracted from both the TOC in the supply water and the TOC in the treated water, and the increase in the TOC was calculated as the difference between the TOC in the treated water excluding the TOC that originated from urea and the TOC in the supply water excluding the TOC that originated from urea. Table 3 shows the results. Since the pressure loss of the supplied water is correlated to the degree of swelling of the resins, as described above, low pressure loss of the supplied water indicates that the resins remained in good condition without swelling. In addition, as the pressure loss of the supplied water decreases, the operation cost of the pump also decreases. The removal rate of urea was 90% or more in Examples 6-1 and 6-2 and Comparative Example 6. An increase in the TOC was limited and an increase in the pressure loss of the supplied water was not observed by setting the dissolved oxygen to 1 mg/L or less.

TABLE 3

| | Concentration of | Pressure | Increase | Removal rate |
|---|---|---|---|---|
| | dissoved oxygen | loss | in TOC | of urea |
| | (mg/L) | (Mpa) | (mg/L) | (%) |
| Example 6-1 | 0.2 | <0.01 | 25 | >90 |
| Example 6-2 | 1 | <0.01 | 95 | >90 |
| Comp. Example 6 | 8 | >0.2 | 1300 | >90 |

### Example 7

The relationship between the concentration of dissolved oxygen and the pressure loss of the resins, and the relationship between the concentration of dissolved oxygen and the TOC were obtained using the same apparatus as in Example 1. 100 mL of ion exchanger resins was loaded into the column and water to be treated was supplied at a flow rate of 12 L/h (SV120(/h)). Specifically, a total of 100 mL of anion exchanger resins and cation exchanger resins were loaded into the column in a mixed bed at a volume ratio of 2:1. Hypochlorous acid was added to the supply water, which was pure water containing dissolved oxygen, at a rate of 0.1 mg-Cl₂/L and the supply water was supplied to the column. AMBERJET 1024 H (manufactured by Organo Corporation) was used as the cation exchanger resins, and AMBERJET 4002 OH (manufactured by Organo Corporation) was used as the anion exchanger resins. The concentration of hypochlorous acid was measured by a salt content meter (manufactured by HANNA). The TOC in the water to be treated was measured by a TOC meter (M9e manufactured by Sievers) at the outlet of the column. The pressure loss of the supplied water and the increase in the TOC were measured for various concentrations of dissolved oxygen in the water to be treated. The increase in the TOC was calculated as the difference between the TOC in the water to be treated at the outlet and the TOC in the water to be treated at the inlet of the column. Table 4 shows the results. In Examples 7-1 to 7-3, an increase in the pressure loss of the supplied water was not observed and the TOC was 20 to 40 μg/L. In Comparative Example 7, the pressure loss of the supplied water was 0.2 MPa or more and the TOC was 100 μg/L.

TABLE 4

| | Concentration of | | |
|---|---|---|---|
| | dissoved oxygen | Pressure loss | Increase in TOC |
| | (mg/L) | (Mpa) | (mg/L) |
| Example 7-1 | <0.005 | <0.01 | 20 |
| Example 7-2 | 0.1 | <0.01 | 20 |
| Example 7-3 | 1 | <0.01 | 40 |
| Comp. Example 7 | 8 | >0.2 | 100 |

### Example 8

An EDI was used instead of an ion exchanger resin column, and the relationship between the concentration of dissolved oxygen and the pressure loss of the EDI, and the relationship between the concentration of dissolved oxygen and the TOC were evaluated in the same manner as in Example 7. The EDI had a first demineralization chamber and a second demineralization chamber, and the water to be treated was supplied to the first demineralization chamber first and then supplied to the second demineralization chamber. Anion exchanger resins were loaded into the first demineralization chamber and cation exchanger resins were loaded into the second demineralization chamber. Anion exchanger resins and cation exchanger resins were loaded into the concentration chamber in a mixed bed. Water was supplied to the first and second demineralization chambers at a flow rate of 20 L/h and was supplied to the concentration chamber at a flow rate of 5 L/h with a current of 0.5 A applied. Hypochlorous acid was added to the supply water, which was pure water containing dissolved oxygen, at a rate of 0.1 mg-Cl₂/L and the supply water was supplied to the EDI. Table 5 shows the results. The increase in the TOC was calculated as the difference between the TOC in the water to be treated at the outlet of the EDI and the TOC in the water to be treated at the inlet of the EDI. An increase in the pressure loss of the supplied water was not observed in Examples 8-1 to 8-3 and the maximum increase in the TOC was 2 μg/L. In Comparative Example 8, the pressure loss was 0.1 MPa or more and the TOC was 14 μg/L.

TABLE 5

| | Concentration of | | |
|---|---|---|---|
| | dissoved oxygen | Pressure loss | Increase in TOC |
| | (mg/L) | (Mpa) | (μg/L) |
| Example 8-1 | <0.005 | 0.02 | <1 |
| Example 8-2 | 0.1 | 0.02 | <1 |
| Example 8-3 | 1 | 0.02 | 2 |
| Comp. Example 8 | 8 | >0.1 | 14 |

Although certain preferred embodiments of the present invention have been shown and described in detail, it should be understood that various changes and modifications may be made without departing from the spirit or scope of the appended claims.

### LIST OF REFERENCE NUMERALS

1A to 1G apparatus for producing pure water
11 filter device
12 activated carbon tower
13 first ion exchanger apparatus
14 ion exchanger loaded apparatus
15 reverse osmosis membrane apparatus
16 ultraviolet ray radiating apparatus (ultraviolet ray oxidization apparatus)
17 second ion exchanger apparatus
18 deaerator apparatus
18A deoxygenation apparatus
19 dissolved oxygen meter
21 means for adding halogen oxoacid
22 means for adding reducing agent
23 additional means for adding halogen oxoacid
27 means for adding oxidizing agent

What is claimed is:

1. A method of producing pure water comprising:
adding halogen oxoacid to water to be treated that contains organic materials; and
supplying the water to be treated to which the halogen oxoacid has been added to an ion exchanger loaded apparatus in which at least anion exchangers are loaded,
wherein concentration of divalent anions in the water to be treated is 0.4 mmol/L or less at an inlet of the ion exchanger loaded apparatus.

2. A water treatment method comprising:
supplying water to be treated that contains an oxidizing agent to a water treatment apparatus that has a water contacting portion that is made of organic materials,
wherein concentration of dissolved oxygen in the water to be treated is 1 mg/L or less at an inlet of the water treatment apparatus.

3. The method according to claim 1, wherein no water treatment apparatus having a water contacting portion that is made of organic materials is provided between a point for adding halogen oxoacid and the ion exchanger loaded apparatus.

4. The method according to claim 1, wherein the water to be treated to which the halogen oxoacid has been added is supplied to the ion exchanger loaded apparatus at a spatial velocity of 1200(/h) or less.

5. The method according to claim 1, wherein the ion exchanger loaded apparatus is non-regenerative.

6. The method according to claim 1, further comprising removing halogen oxoacid downstream of the ion exchanger loaded apparatus.

7. The method according to claim 1, wherein concentration of dissolved oxygen in the water to be treated is 1 mg/L or less at an inlet of the ion exchanger loaded apparatus.

8. The method according to claim 7, further comprising a deoxygenation apparatus that is positioned upstream of the ion exchanger loaded apparatus, wherein the deoxygenation apparatus adjusts the concentration of dissolved oxygen in the water to be treated to 1 mg/L or less at the inlet of the ion exchanger loaded apparatus.

9. The method according to claim 8, further comprising:
a dissolved oxygen meter that measures the concentration of dissolved oxygen in the water to be treated at an outlet of the deoxygenation apparatus; and
a control unit that controls the deoxygenation apparatus such that the concentration of dissolved oxygen that is measured by the dissolved oxygen meter is 0.1 mg/L or more and 1 mg/L or less based on the concentration of dissolved oxygen that is measured by the dissolved oxygen meter.

10. The method according to claim 1, wherein mass concentration of halogen oxoacid in the water to be treated is 6 times or more than total organic carbon in the water to be treated at an inlet of the ion exchanger loaded apparatus.

11. The water treatment method according to claim 2, further comprising a deoxygenation apparatus that is positioned upstream of the water treatment apparatus, wherein the deoxygenation apparatus adjusts the concentration of dissolved oxygen in the water to be treated to 1 mg/L or less at the inlet of the water treatment apparatus.

12. The water treatment method according to claim 2, further comprising adding oxidizing agent upstream of the water treatment apparatus.
